(19) United States
(12) Patent Application Publication
(10) Pub. No.: US 2018/0232831 A1
(43) Pub. Date: Aug. 16, 2018

(54) Systems and Methods For Awarding Tuition Tax Credit Scholarships

(71) Applicant: Institute for Better Education, Tucson, AZ (US)

(72) Inventors: Charlotte E. Beecher, Tucson, AZ (US); Kimberly Jean Kirschner, Tucson, AZ (US); Amanda Leigh Bryant, Tucson, AZ (US)

(21) Appl. No.: 15/431,476

(22) Filed: Feb. 13, 2017

(51) Int. Cl. G06Q 50/20; G06Q 20/10; G06Q 30/02; G06Q 40/00

(52) U.S. Cl. CPC G06Q 50/2053; G06Q 40/10; G06Q 30/0279; G06Q 20/10

(57) ABSTRACT

A method for processing tuition tax credit donations, comprising the steps of: prompting a donor to indicate whether a combined state tax credit and federal deduction is sought, or whether a federal charitable deduction alone is sought; prompting the donor to enter an original donation amount; prompting the donor to enter a first recommended recipient for the original donation amount; prompting the donor to enter a plus donation amount; prompting the donor to enter a second recommended recipient for the plus donation amount; and simultaneously executing a single credit/debit transaction for both the original and plus donation amounts.

### TECHNICAL FIELD

The present invention relates, generally, to systems and methods for processing tuition tax credit donations and allocating tuition scholarships and, more particularly, to an integrated system for managing scholarship funds from multiple sources.

### BACKGROUND

Many states have enacted their own versions of tuition tax credit statutes to promote school choice. At least one statutory scheme allowed a donor (or married couple filing jointly) to make an initial donation (sometimes referred to herein as an “original” donation), and software systems were developed to track the donations and manage the allocation of the donations to schools and to particular students in the form of scholarships. Over time, the scheme evolved to also allow individual taxpayers to also make an additional donation (sometimes referred to herein as a “plus” donation), and software modules were developed to manage the plus donations. The scheme further evolved to contemplate third and fourth categories of donations, sometimes referred to herein as “low income corporate and disabled/displaced corporate,” donations, respectively, for which additional software tools were developed. (See, for example, https://www.azdor.gov/TaxCredits/SchoolTaxCreditsforIndividuals.aspx). As a result, presently known systems for coordinating donations and awarding scholarship monies to students essentially comprise an ad hoc bundle of independent tracking modules and associated databases, resulting in cumbersome and inefficient approaches to managing donations and scholarships. For example, if a donor desired to make a single donation including both an original and a plus component, the system would process the two donations separately, resulting in duplicative systems and duplicative efforts by administrative personnel.

Typical statutory schemes authorize school tuition organizations (STO) to manage and administer the receipt of donations and the awarding of scholarships under guidelines calculated to enhance school choice policy objectives, while restricting scholarships based solely on donor recommendations.

Presently known systems process donations into the following funds: i) original; ii) plus (also known as “switcher”); iii) low income corporate; and iv) disabled/displaced corporate. Presently known STO management systems typically comprise multiple software modules configured to process the donations independently, which renders coordination among the four categories cumbersome and time consuming.

Systems and methods are thus needed which overcome these limitations. Various desirable features and characteristics will also become apparent from the subsequent detailed description and the appended claims, taken in conjunction with the accompanying drawings and this background section.

### BRIEF SUMMARY

Various embodiments of the present invention relate to an improved system for managing tuition tax credit donations and awarding scholarships from multiple fund sources.

Various other embodiments, aspects and features are described in greater detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a block diagram of a prior art system for managing donations and awards which employs a plurality of independent processing platform for each scholarship fund, respectively;

FIG. 2 is block diagram of an exemplary system including an integrated processing system for managing multiple funds from multiple donor sources in accordance with various embodiments;

FIG. 3 is a schematic flow diagram illustrating a single web application having a donor portal, an applicant portal, and a school portal and a single scholarship award manager (SAM) module configured to manage donations from multiple donor sources and to process awards to students and schools based on multiple categories of eligibility requirements in accordance with various embodiments;

FIG. 4 is a schematic block diagram of an exemplary database structure configured to partition a plurality of funds in accordance with various embodiments;

FIGS. 5-9 are screen shots of web pages depicting an exemplary donation process flow in accordance with various embodiments;

FIGS. 10-12 are screen shots of web pages depicting an exemplary merging process flow for linking donations with recipients in accordance with various embodiments;

FIGS. 13-17 are screen shots of web pages depicting an exemplary student application process flow in accordance with various embodiments; and

FIGS. 18-23 are screen shots of web pages depicting an exemplary process flow for awarding scholarships in accordance with various embodiments.

### DETAILED DESCRIPTION OF PREFERRED EMBODIMENTS OF THE INVENTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to an integrated system for managing the receipt of donations from individual taxpayers and corporations, and for allocating the donations to scholarship categories including original, plus, low income, and disabled/displaced corporate.

Typical statutory schemes require that a donor recommendation cannot be the sole criterion for awarding a scholarship; other factors must also be considered, particularly “need” based circumstances including family income and/or extenuating circumstances. To monitor and ensure compliance with the policy objectives, the school tuition organization (STO) which awards scholarships must report household information (particularly family income) for the scholarship recipients to the state Department of Revenue.

In order to facilitate both the award and reporting processes, the student applicant must also register with the STO separately from the donor, so that the system can capture family income and related circumstances upon which the awards are ultimately based. Although awards may be based on donor recommendations, family income, and other circumstances, the awarding organization has discretion as how they choose to allocate scholarships; that is, they can apply more or less weight to a donor's recommendation as long as other factors are also considered.

Moreover, donations must be unconditional in order for the donor to be entitled to the tax credit. Hence, the STO strives to avoid even the appearance of a conditional donation. For example, if donor recommends a particular student for whom tuition is already paid, the money may be held by the STO for a subsequent year, but may not be returned to the donor, nor does the STO contact the donor to request an alternate recipient. The STO may, however, contact the parents to see if the money can be awarded within the immediate family.

An exemplary statutory scheme may provide for an “original” donation to any child in a private school, and a “plus” donation which can go to any eligible student in a private school. More particularly, the scheme recognizes various eligibility categories and corresponding scholarship funds, including:

Original: i) disabled pre-kindergarten; ii) kindergarten-12; iii) private school.

Plus (sometimes referred to as “switcher”): i) disabled pre-kindergarten; ii) kindergarten; iii) switching from an Arizona public school to an Arizona private school within the last year; iv) military dependent residing in Arizona on orders; v) a prior recipient of a corporate low income scholarship; vi) a prior recipient of a disabled/displaced (D/D) corporate scholarship; vii) a current “plus” scholarship recipient; viii) a prior “plus” scholarship recipient.

Low Income Corporate: i) disabled pre-kindergarten; ii) low income; iii) one of Kindergarten, switcher, military, prior or current corp recipient, or previous Plus or Original recipient.

Disabled/Displaced Corporate (D/D): i) disabled pre-kindergarten; ii) Kindergarten-12; and iii) in Arizona state foster care at any time or received from an Arizona state public school a multidisciplinary evaluation team (MET) or individual education plan (IEP) or a 504 plan.

More particularly, the original and plus funds are funded through donations from individual taxpayers (the original contribution amount must first be satisfied before a plus donation may be made), whereas the low income corporate and D/D funds are funded through donations from corporations.

In accordance with one aspect of the present invention, past donations and past recommended recipients are displayed for registered donors, allowing the donor to click on a prior year recommended recipient to thereby recommend the same recipient for the current year.

In accordance with a further aspect of the invention, if a donor recommends a student who has not yet registered with the STO, the STO can create a place holder in the donor record for an unknown child and later match the donation to the child after the child registers.

Another embodiment includes an interactive component which allows a registered applicant to upload supporting documents (e.g., extenuating circumstances letter, military orders) and thereby effect a change in status of a color coded eligibility documentation indicator.

Another embodiment allows a registered applicant to see all the award types he/she is eligible for on a single screen, along with the status of supporting documentation.

In another embodiment, the system tracks the school's payment preference/requirement (EFT, paper check); this can be important when issuing large numbers of payments in a short period of time.

Another embodiment provides a matrix which defines the maximum amount of disabled/displaced corporate awards a child may receive. The STO enters the child's grade, disability, and/or foster status, and the system outputs the maximum allowable award based on the matrix.

Prior art systems processed all awards, but were not configured to determine whether an award would (and sometimes did) exceed the amount of a student's tuition, in part because separate (autonomous) modules were used to allocate different scholarship funds. As a result, in accordance with an embodiment, the present invention system will not allow an award to be granted if to do so would exceed the total tuition for a student.

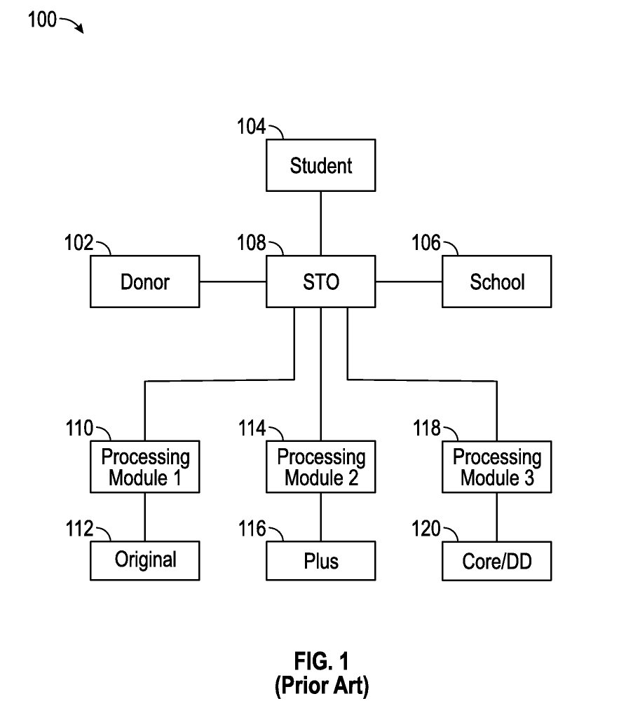

Referring now to FIG. 1, en exemplary prior art system 100 for processing donations and awarding scholarships involves interaction among donors (including individual and corporate donors) 102, student applicants 104, participating schools 106, and an STO 108. In the illustrated embodiment, the STO 108 employs a first processing module no to process payments for funding an original scholarship fund 112, a second processing module 114 to process payments for funding a plus scholarship fund 116, and one or more additional processing modules 118 to process payments for funding one or more additional scholarship funds (e.g., low income corporate and D/D) 120. Because each of the processing modules 110, 114, and 118 operate autonomously, STO administrative personnel are required to separately manage multiple data flows, resulting in unnecessary complexity and repetitive tasks.

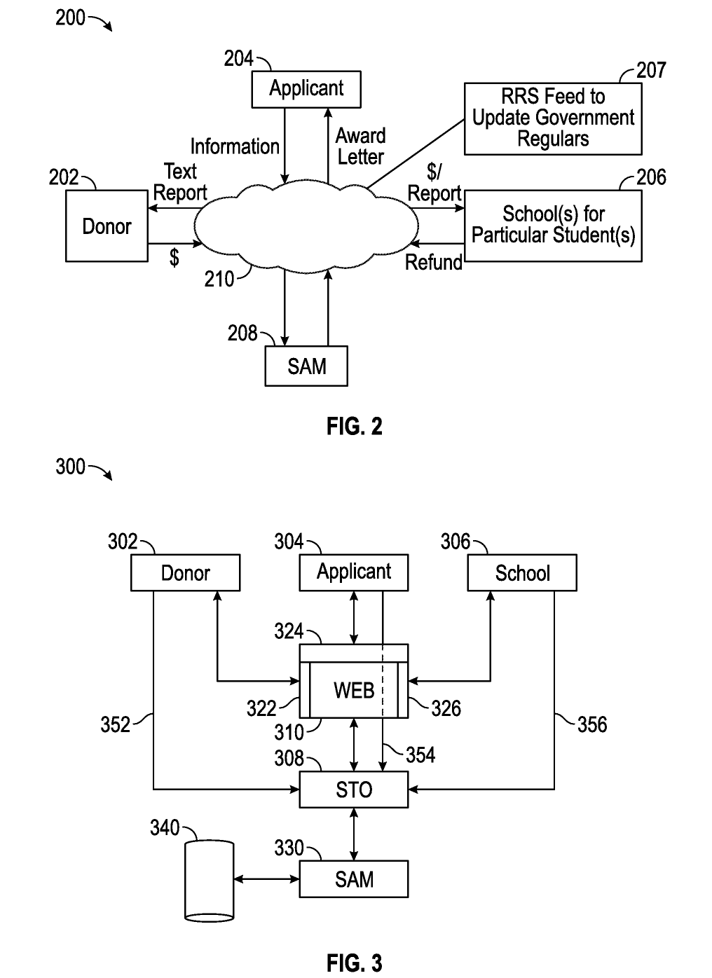

FIG. 2 illustrates an exemplary system 200 for processing donations and awarding scholarships in accordance with the present invention. More particularly, the system 200 involves interaction among donors (including individual and corporate) 202, student applicants 204, schools 206, and an STO 208 coordinated through a cloud based network 210 (such as the internet). Significantly, the STO 208 of the present invention employs a single integrated processing regime for coordinating multiple scholarship funds from a plurality of donor sources, as described in greater detail below. If desired, the system 200 may also include a communications module 207 (e.g., an RSS feed) 207 for updating the STO processing system with current donation limits, eligibility criteria, and other statutory and regulatory metrics.

Referring now to FIG. 3, an exemplary schematic diagram 300 in accordance with the present invention depicts a donor 302, an applicant 304, a school 306 configured to interact with a web site 310 and an STO 308. In the illustrated embodiment, the web site 310 includes a donor facing portal 322, an applicant facing portal 324, and a school facing portal 326. For completeness, the system 300 also contemplates traditional interaction between donors and the STO via mail, courier, telephone, fax, or in-person, along vector 352. Similarly, an applicant or a school may interact with the STO via mail, fax, in person, or the like, along vectors 354 and 356, respectively.

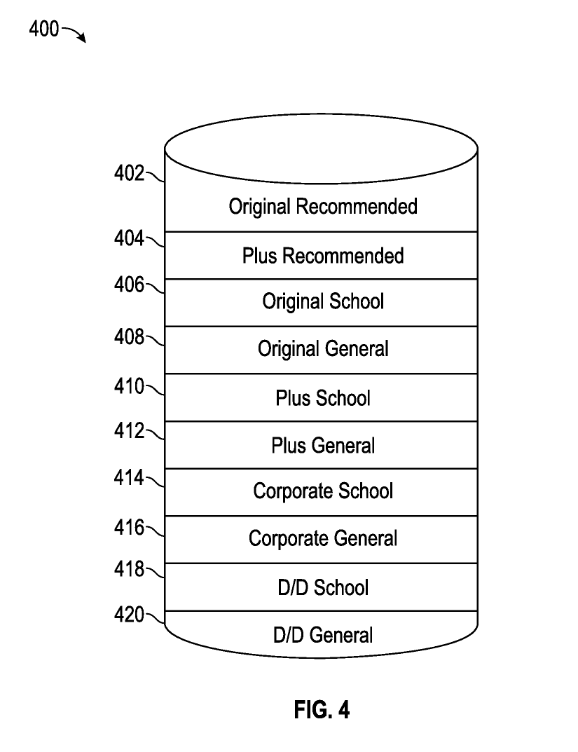

In a preferred embodiment, when donors, applicants, or schools interact with the STO along vectors 352, 354, and 356, the STO administrators typically enter data into an application such as a scholarship award manager (SAM) 330 directly. Conversely, when the donors, applicants, and schools interact with their respective web portals, the data is typically staged in the website for batched entry by STO personnel into the SAM system, as described in greater detail below. The SAM system suitably includes or otherwise communicates with a database 340, as described further in conjunction with FIG. 4.

Referring now to FIG. 4, an exemplary database structure 400 configured for use by SAM 330 may include at least the following data sectors for partitioning corresponding scholarship funds: i) an original recommended fund 402; ii) a plus recommended fund 404; iii) an original school fund 406; iv) an original general fund 408; v) a plus school fund 410; vi) a plus general fund; vii) a low income corporate school fund 414; viii) a low income corporate general fund 416; ix) a D/D school fund 418; and x) a D/D general fund 420. It will be appreciated that the data structure 400 and SAM 330 may contemplate any combination of scholarship funds, each of which may have different eligibility requirements and donation sources as provided by applicable statutes, regulations, and policies.

Because donors and applicants do not directly access SAM 330, SAM includes front end protocols which allow the STO to merge donations with student accounts according to a set of rules. These rules, as implemented by the STO, thus act as a firewall to ensure that scholarships are awarded in accordance with the statutory scheme, for example, by preventing a donor from directing funds to a student without the application of appropriate business rules and safeguards. By way of non-limiting example, in a straightforward use case a donor may recommend a particular student to receive a donation, but SAM ensures that family income and other circumstances are considered to avoid directly awarding a donation to the recommended student.

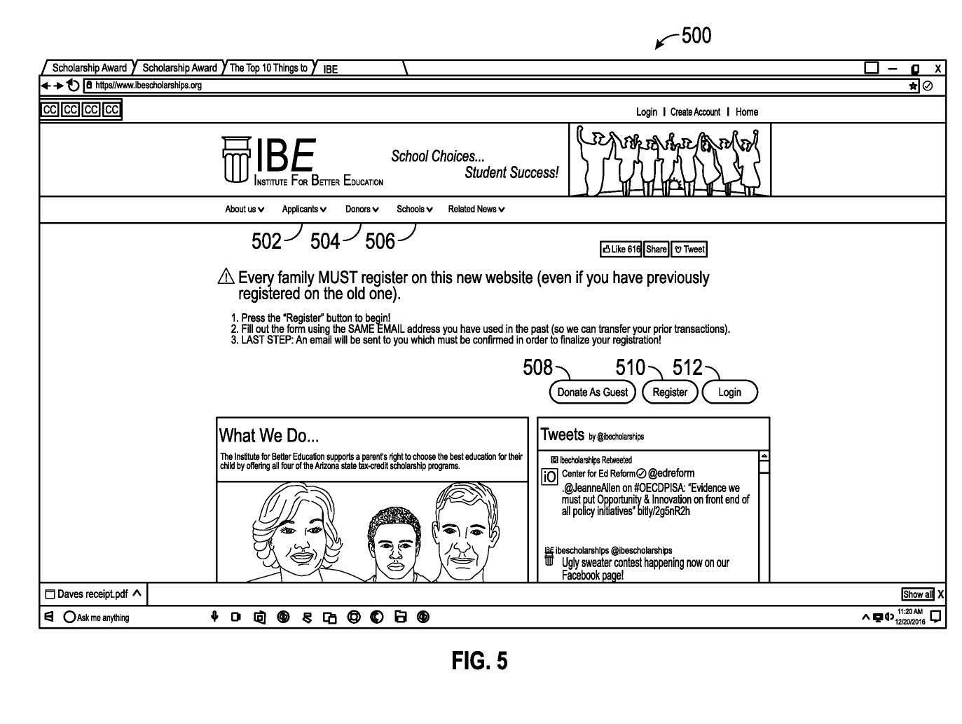

Referring now to FIGS. 5-9, an exemplary process flow for facilitating donations generally involves: i) accessing the donor portal of the STO website by an individual or corporate donor; ii) registering as a new donor or logging in as an existing registered donor; iii) electing to initiate a donation; iv) indicating whether a combined state tax credit and federal deduction is sought, or whether a federal charitable deduction alone is sought (out of state donors are not eligible for a state tax credit); v) confirming which tax year the donation applies to (the process defaults to the then current calendar year except from January 1 through April 15, during which either the current or prior tax year may be selected); vi) after being advised as to the available remaining tax credit (accounting for any previous donations), the donor is prompted to enter a donation amount; vii) the donor is prompted to enter one or more recommendations (e.g., a particular student, a particular private school selected from a drop down list, or a general fund); viii) if the donation meets the maximum allowable original amount, an individual donor is prompted to also make a plus donation and associated recommendation; ix) prompting to donor make a federal charitable contribution; x) processing the donation, e.g., by executing one or more credit/debit transactions; and xi) prompting the donor to request a tax credit receipt.

More particularly and referring now to FIG. 5, a landing page 500 includes an applicant tab 502, a donor tab 504, a school tab 506, a donate as guest tab 508, a register tab 510, and a login tab 512. The applicant, donor, and school tabs 502, 504, and 506 direct the user to navigate to the corresponding portals associated with the STO website, as described in greater detail below. The donate as a guest tab 508 and associated functionality allows a user to make a donation without registering as a donor. The register tab 510 directs the user to register as a donor, applicant, or school partner, while the login tab 512 allows a previously registered donor, applicant, or school to access their associated records within the system.

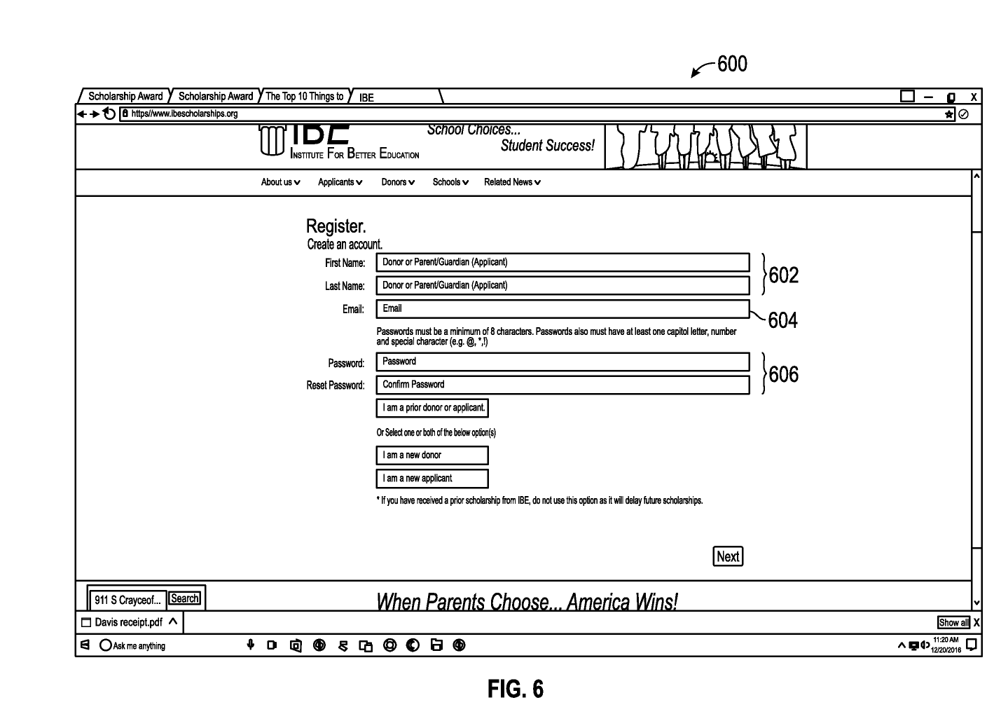

FIG. 6 depicts a screen shot of a combined donor/applicant registration page 600 configured to allow either a new or existing donor or applicant to register with the system. For a donor, the page 600 includes name fields 602, an email field 604, password fields 606, and a new/existing donor field. The applicant registration process is discussed following this description of the donor registration and donation process.

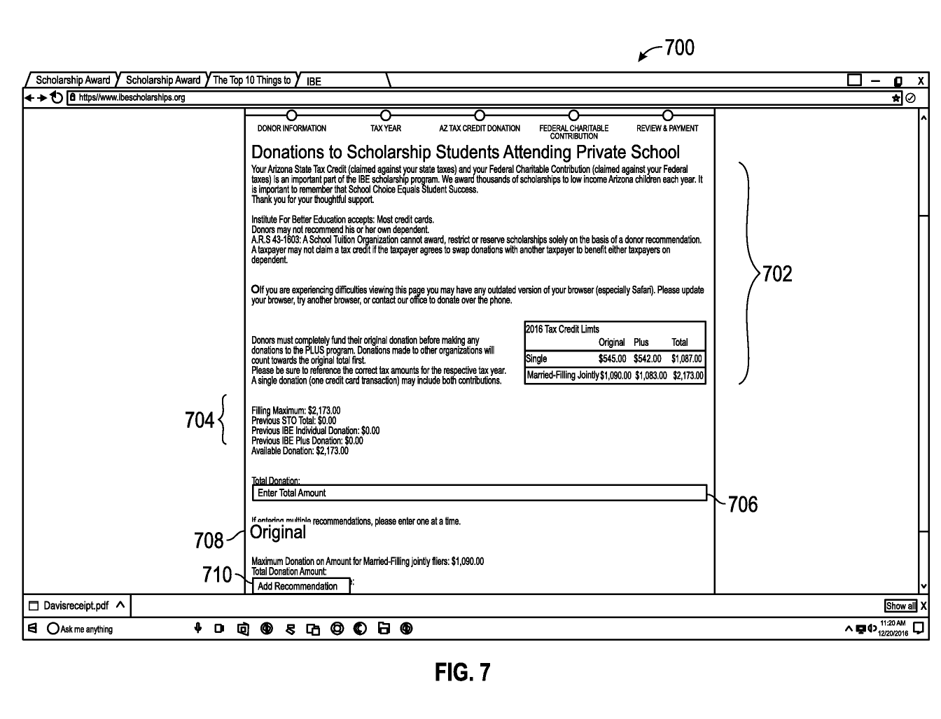

FIG. 7 depicts a screen shot of an exemplary donation page 700 including an advisory field 702, a previous donation field 704, an amount field 706, a summary field 708, and a recommendation option field 710.

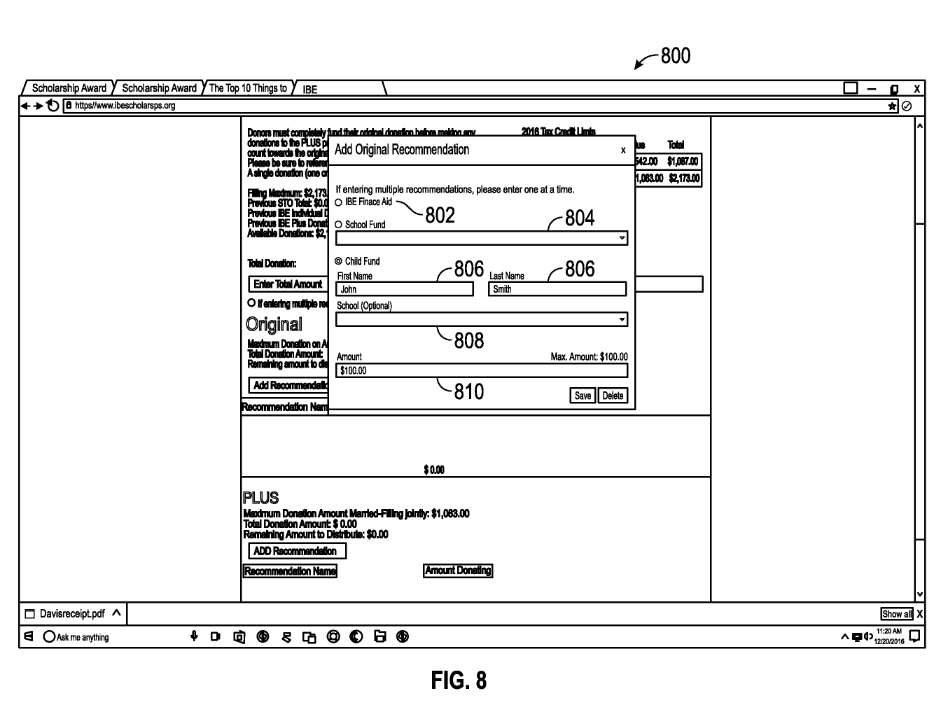

More particularly, the advisory field 702 sets forth the current tax credit donation limits and other information helpful to a donor, and may suitably be received via an RSS feed or other data service. The previous donation field 704 allows the user—at a glance—to view previous donations with this particular STO and, hence, the amount of available tax credit donations remaining under the statutory scheme to assist the user in determining the amount of the current donation. The amount field 706 may be entered, for example, using previous donation amounts as a guide. The summary field 708 may include the total current (and/or past) donations into one or more scholarship funds and, if desired, may be adjusted in real time as the amount of the current donation is determined. The recommendation option field 710 may be configured to allow the donor to recommend a particular student and/or school for one or more of the current donations, as described in greater detail below in conjunction with FIG. 8.

FIG. 8 depicts a screen shot of an exemplary original recommendation page 800 including one or more recommendation options such as an original general fund option 802, an original school fund option 804 which may include a pull down menu of schools previously registered with the STO, an original recommended child fund 806, or an original school fund option 808 which allows the donor to enter a school which has not yet registered with the STO. The amount of the current donation which the donor desires to associate with the recommendation may be entered into an amount field 810.

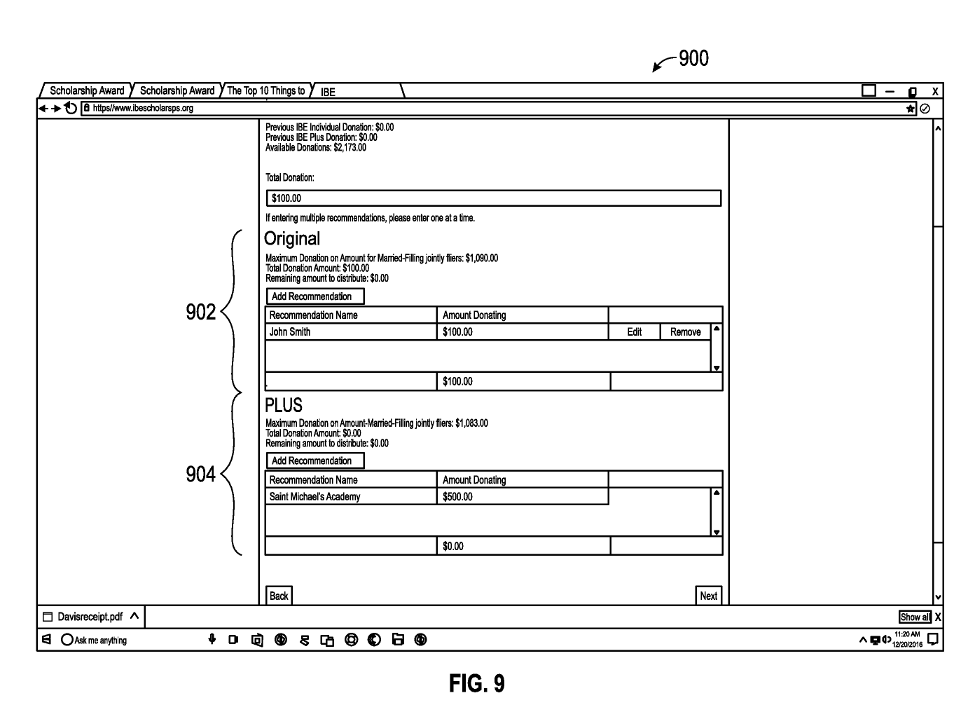

Those skilled in the art will appreciate that variations of the foregoing recommendation page 800 may be provided for other donation categories such as plus and low income corporate. For example, FIG. 9 depicts a screen shot of an exemplary recommendation page 900 including both an original donation recommendation summary section 902 confirming “John Smith” as the recommended student recipient of an original donation, and a plus donation recommendation summary section 904 confirming “Saint Michael's Academy” as the recommended school recipient of a plus donation.

After a donor completes a donation (with or without a recommendation) via the donor portal, the STO administrative personnel thereafter merge the donation into SAM, which then applies a rules engine to endeavor to match the donation to a student and/or school (if recommended), or to an appropriate fund if no recommendation is made. Although the donor's recommendation may be honored after applying the rules, if appropriate, the merge process generally does not happen in real time, as scholarship decisions often involve subjective discussions among members of a scholarship award committee. As described in greater detail below, the recommended child (or school) must also register with the system and provide financial need information (particularly family income) to allow the committee to objectively and/or subjectively evaluate the propriety of the recommendation in the context of the statutory scheme and the supporting eligibility documentation.

An exemplary process flow for merging donations staged in the donor portal into SAM generally involves: i) accessing, by STO administrative personnel, a list of staged donors and their associated donations and recommendations for a particular date range (e.g., the previous day); ii) serially accessing each donor record, including the donor's current and past donations; iii) for a current unlinked recommendation, SAM retrieves and displays the child's information if the child is registered, otherwise SAM prompts the STO administrator to add an “unknown child” record; iv) clicking on the child name field to link the recommended recipient to the donation (this will subsequently be presented to the scholarship committee for evaluation along with related supporting documentation and information relating to family need and income); v) the donation is partitioned into an administrative portion (e.g., 8%) and a net donation portion (e.g., 92%); vi) the net donation portion is then merged into SAM; vii) SAM populates the child's record with the linked net donation (although the donor name is not visible to the child's family using the applicant portal).

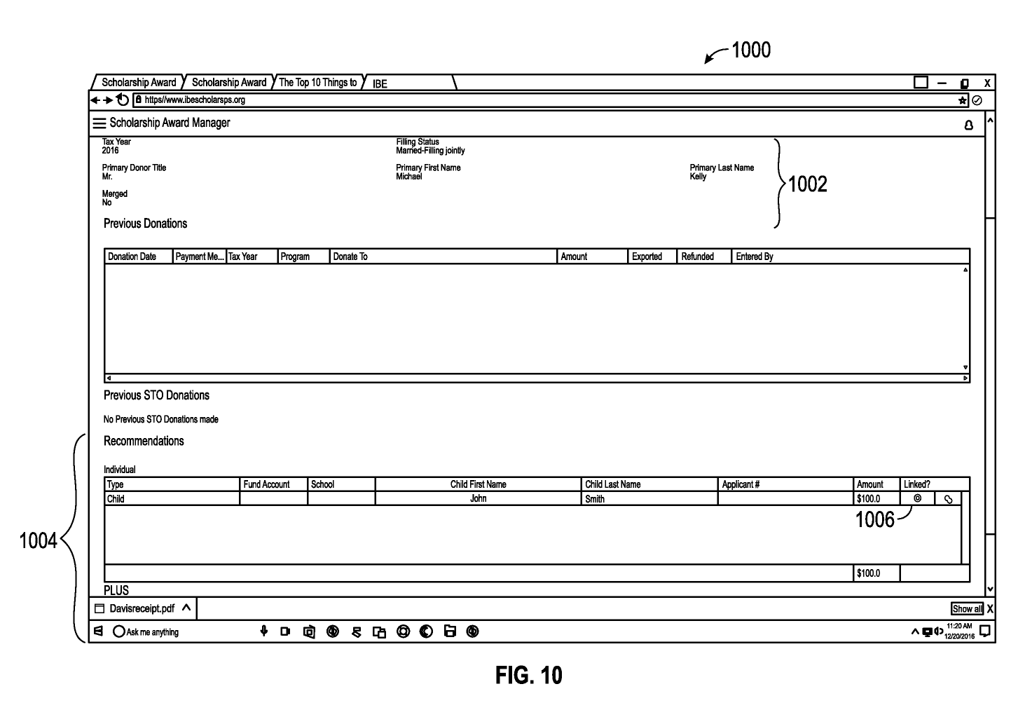

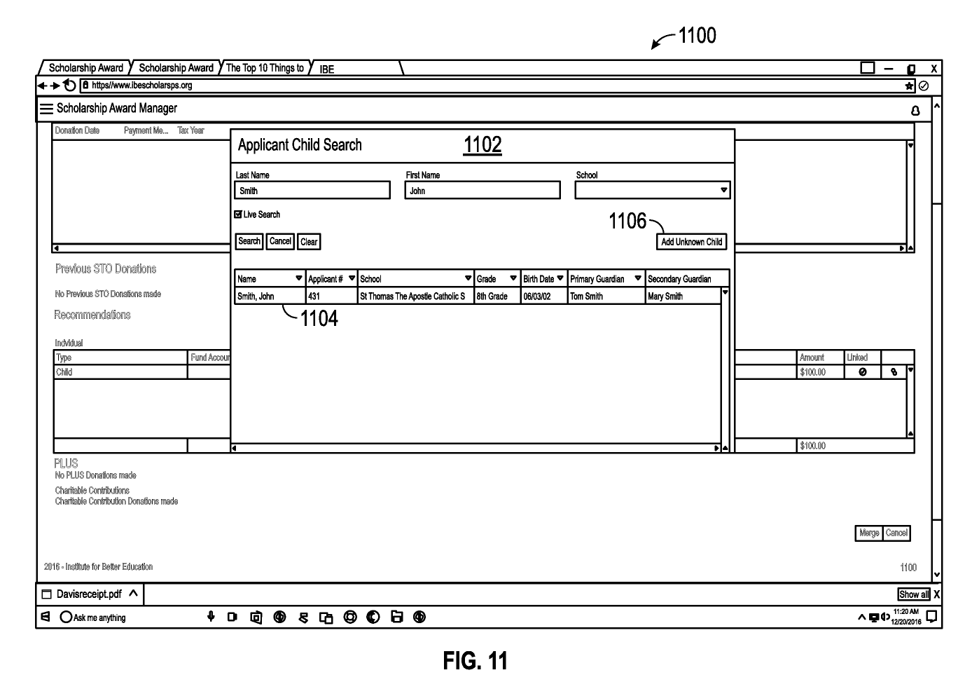

More particularly and referring now to FIG. 10, a screen shot of an exemplary unlinked donor recommendation page 1000 depicts a donor field 1002 and an unlinked recommended recipient (in this case a student John Smith) including an icon 1006 indicating that the donation is not yet linked with the intended student recipient. To facilitate linking the donation with the recommended recipient, SAM may be configured to retrieve information pertaining to the recommended student if that student has previously registered with the system. As shown in FIG. 11, if the recommended recipient has already registered, SAM displays the student record 1102 (including school name, grade, DOB, and parent name(s)).

Having confirmed that the recommended recipient is indeed registered with the STO, the system prompts the administrator to link the donation with the student, for example by clicking on the child's name field 1104. If, on the other hand, the intended recipient is not registered, the system prompts the administrator to click an unknown child link 1106 to effectively “hold” the donation until the child later registers with the system. Note, however, that the donation cannot be awarded to the recommended recipient as a scholarship unless and until the rules engine is applied, as described in greater detail below.

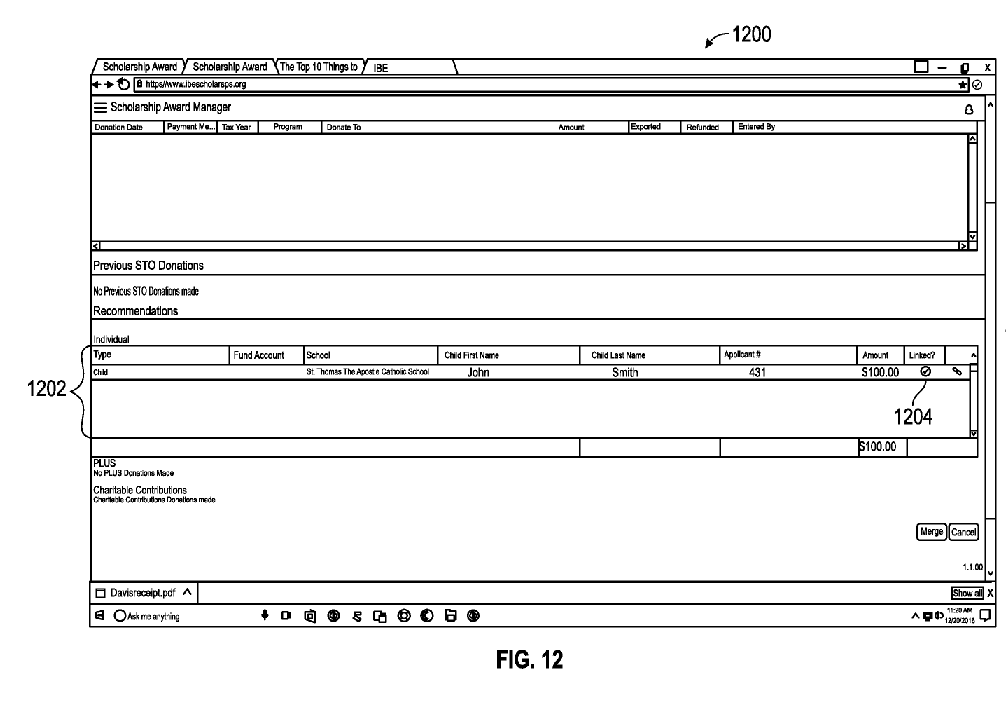

FIG. 12 is a screen shot of an exemplary linked donation page 1200 depicting a linked field 1202 having an icon 1204 which visually confirms that the donation is now linked into the child's record. In accordance with a preferred embodiment, the icon 1006 (FIG. 10) may be color coded red to provide a visual cue that the donation is not yet linked, whereas the icon 1204 may be color coded green to provide a visual cue that the donation is linked. Color coding key fields in this manner allows administrators to quickly and efficiently merge a large number of donations with intended registered recipients (including students and schools).

Rather than donating via the donor portal, a donor may alternatively donate by sending a fax, mailing a letter, visiting the STO in person, or calling in the donation using a telephone, whereupon the STO may enter the information directly into SAM in lieu of merging information from the web portal into SAM, as described in conjunction with FIGS. 10-12, above.

An exemplary process flow for registering a child with the STO in accordance with various embodiments generally involves: i) logging onto the STO website; ii) accessing the applicant portal; iii) registering as an applicant family by entering, for example, parents names, address, contact information, password); iv) prompting the applicant to enter total family income and number of family members living in the household; v) prompting the applicant to enter, for each eligible child in the family, the child's name, private school name, birth date, grade, and tuition amount; vi) prompting the applicant to disclose extenuating circumstances giving rise to financial hardships, if any; vii) prompting the applicant to disclose eligibility qualifications; and viii) prompting the applicant to upload eligibility supporting documentation.

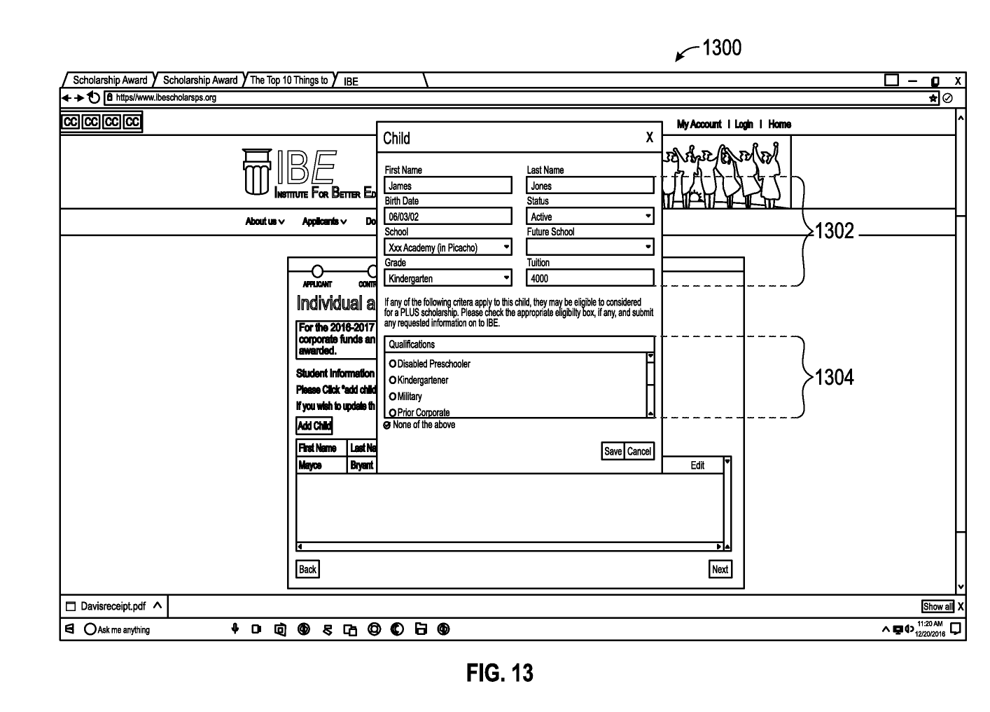

More particularly and referring now to FIG. 13, a screen shot of an exemplary application page 1300 includes a personal information section 1302 and a qualifications section 1304. The personal information section 1302 prompts the applicant to enter information such as, for example, the child's name, DOB, school, grade, and tuition amount. The qualifications section 1304 prompts the applicant to identify one or more circumstances potentially impacting the child's eligibility for various scholarship programs such as, for example, disabled preschooler, military, kindergartener, prior low income corporate scholarship recipient, prior D/D scholarship recipient, prior plus scholarship recipient, current switcher from an Arizona public to a private school in the state, and the like. Those skilled in the art will appreciate that the criteria listed in the qualifications section 1304 may be adapted from the eligibility requirements defined for the various scholarship funds managed by the STO, as they may vary from time to time (and from state to state). In the embodiment illustrated in FIG. 13, the qualifications section 1304 queries the applicant for circumstances relevant to eligibility for original and plus scholarships; different qualification criteria may be solicited for an applicant applying for other programs such as low income corporate and D/D (although typically D/D cannot be applied for online).

By way of partial summary, by indicating the various qualifications applicable to a child, the applicant thereby indicates a desire to apply for scholarships from the corresponding funds such as: i) individual (Arizona private school, and in grade k-12 or disabled preschooler); ii) plus (kindergarten, switching from an Arizona public to private within a year, military dependent traveling on orders, prior plus recipient, prior low income corporate recipient in any previous year, prior disabled/displaced corporate in any previous year); and iii) low income corporate (low income requirement, and Kindergarten or switcher, military, prior or current low income corporate, or previous plus or individual). In this regard, to be income eligible for low income corporate scholarship funds the family income must be less than a predetermined level, such as 185% of the federal poverty level.

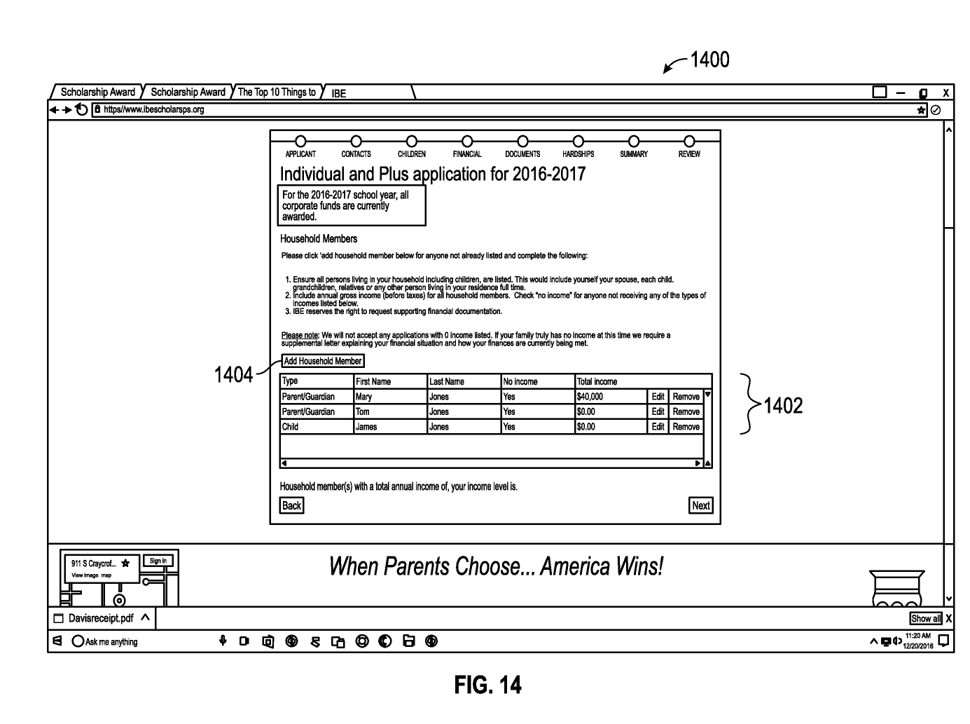

With reference to FIG. 14, the system presents the applicant with a then current summary 1402 of household members and associated incomes, and prompts the user to add additional household members (including but not limited to students seeking scholarships), if any, by clicking an add household members navigation link 1404.

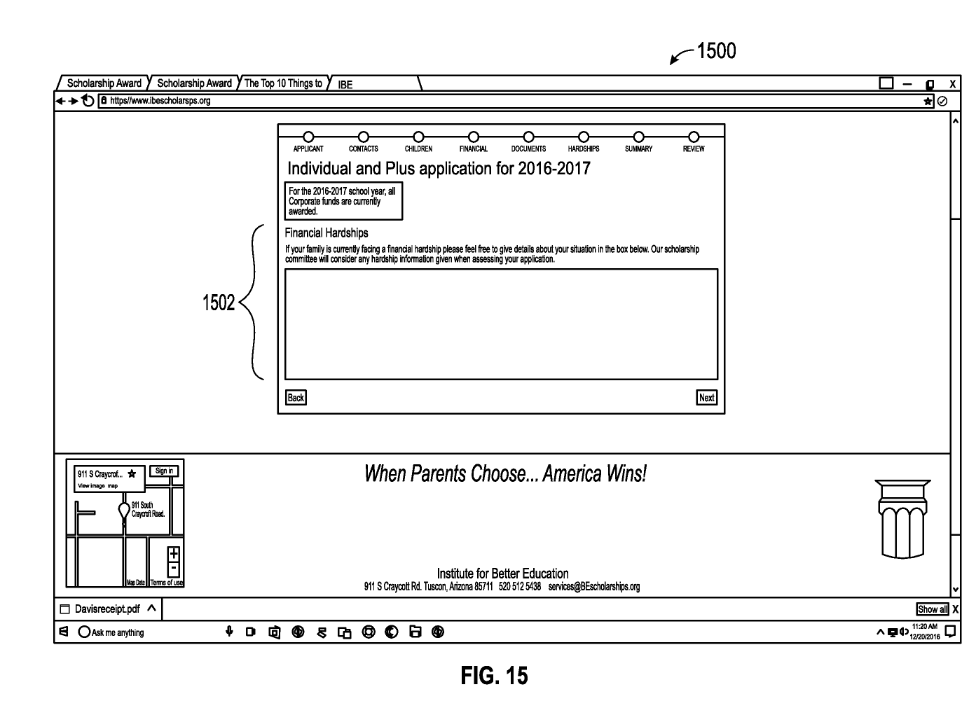

Referring now to FIG. 15, a screen shot of an exemplary hardship page 1500 includes a hardship filed 1502 for entering hardship details which will be forwarded to the scholarship committee to consider when awarding scholarships.

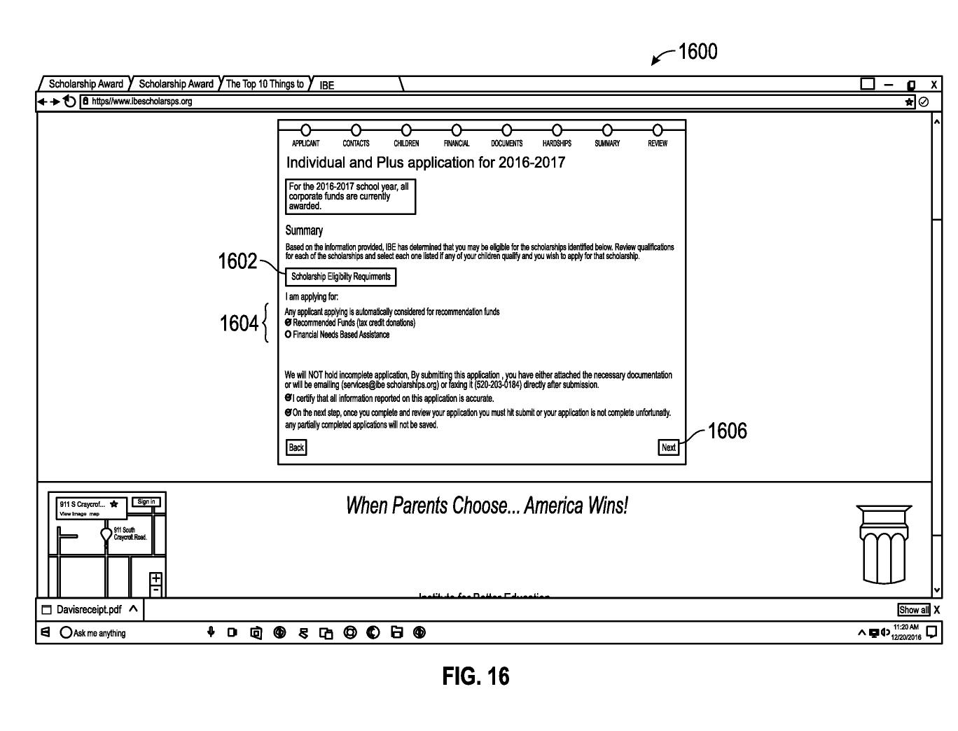

FIG. 16 is a screen shot of an exemplary submission page 1600 depicting a summary 1604 of scholarship funds for which the applicant is potentially eligible, an eligibility requirements button 1602 for use in reviewing eligibility requirements, and a submission button 1606 for submitting the completed application. More particularly, the summary 1604 suggests those scholarships which the system has determined—based on the applicant's information—which scholarships the applicant is potentially eligible for, and invites the applicant to select which scholarships the applicant would actually like to apply for. If the applicant is unsure whether the qualifications are met for one or more funds, the applicant can elect to review the requirements by clicking button 1602 to reveal a detailed requirements/eligibility list.

After confirming all scholarships the applicant seeks to apply for, applicant submits the application. The STO administrator then merges the staged applicant information into SAM, analogous to the merging process discussed above in the context of merging donor information into SAM. During the applicant merge process, the STO administrator also leverages the color scheme to track eligibility documentation. The foregoing color scheme also alerts applicants to upload documents to advance from red to green eligibility status during the application process.

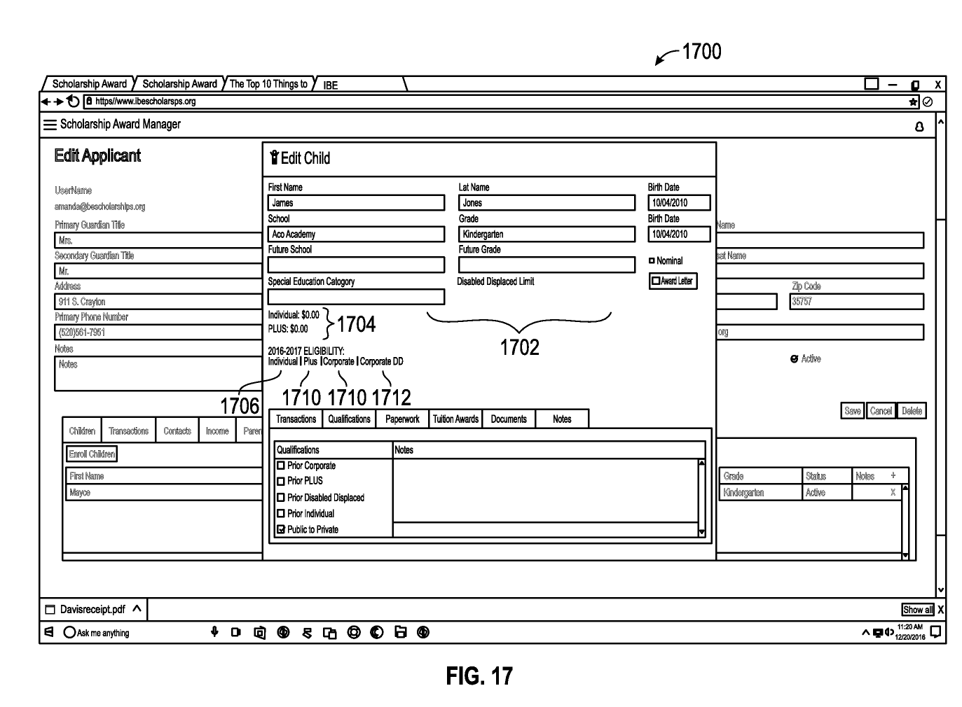

More particularly and referring now to FIG. 17, a screen shot of an exemplary applicant intermediary merging page 1700 depicts an applicant field 1702, an awards status field 1704, a first green color coded field 1706 indicating that the documentation requirements for an individual scholarship have been completed, a second red color coded field 1708 indicating that the documentation requirements for a plus scholarship have not been completed, a third red color coded field 1710 indicating that the documentation requirements for a low income corporate scholarship have not been completed, and a fourth grey color coded field 1712 indicating that the applicant is not eligible for a D/D scholarship. By color coding the status of eligibility documentation for various funds, both administrators and applicant families can quickly ascertain what steps need to be taken to move the application process from red to green; that is, by identifying those funds for which documentation is still incomplete.

Having now described exemplary processes by which donors and applicants register and otherwise interact with SAM, it remains to discuss the manner in which scholarships are awarded to schools and students, and the manner in which payments are made to the schools.

An exemplary process for awarding scholarships to schools and individual students at a particular school may include: i) sequentially selecting one from a list of students for each category of awards (recommended, financial need, low income corporate, disabled/displaced corporate); ii) confirming eligibility documentation; iii) subjectively evaluating uploaded documents, applications, recommendations, and policies to assist in award decisions; vi) transmitting a summary of students and associated scholarships to each school; v) receiving confirmation from the school that each student is still enrolled and that a tuition balance exists; and vi) processing one check to each school for each type of scholarship.

Succinctly, a typical statutory scheme contemplates donations from individuals and corporations into original, plus, corporate, and D/D scholarship funds. The funds are then awarded to students based on donor recommendations and financial need, and otherwise in accordance with protocols adopted by the STO to comply with applicable rules and statutes.

More particularly, financial need based scholarships are awarded based on a subjective evaluation of many factors, whereas recommended scholarships are more straightforward (though not automatic—the committee considers each one independently). An individual donor can recommend a child, a school, or general fund. The plus component can be awarded: i) to a particular child (with financial need) based on a donor recommendation; ii) to a school; or iii) to a plus general fund.

SAM assists in awarding financial need funds by providing drop down menus to the STO administrator. For example, when making individual awards for financial need the STO scholarship committee reviews a report of all eligible applicants who applied for scholarship awards within a date range. STOs grant awards on a discretionary schedule, such as tri-annually. An administrator confirms that the documentation is in order for each student at each school. The scholarship committee then allocates the money sourced from individual contributions among the eligible applicants. The STO strives to honor donors' recommendations to a school and typically applies those funds to the recommended school; the STO thereafter allocates the funds among eligible students at that school subjectively based on need.

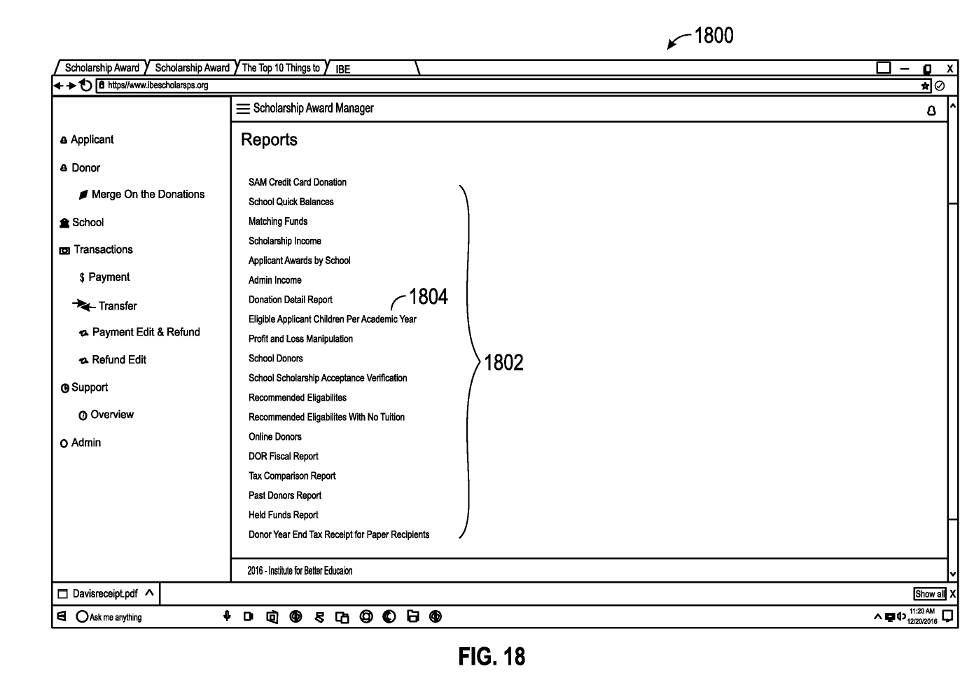

FIG. 18 is a screen shot of an exemplary reports landing page 1800 depicting a summary of available interim reports 1802 useful on awarding scholarships, including a report entitled “Eligible Applicant Children Per Academic Year Report” 1804. Clicking on the report 1804 prompts the STO administrator to configure the specific information to be displayed on the report.

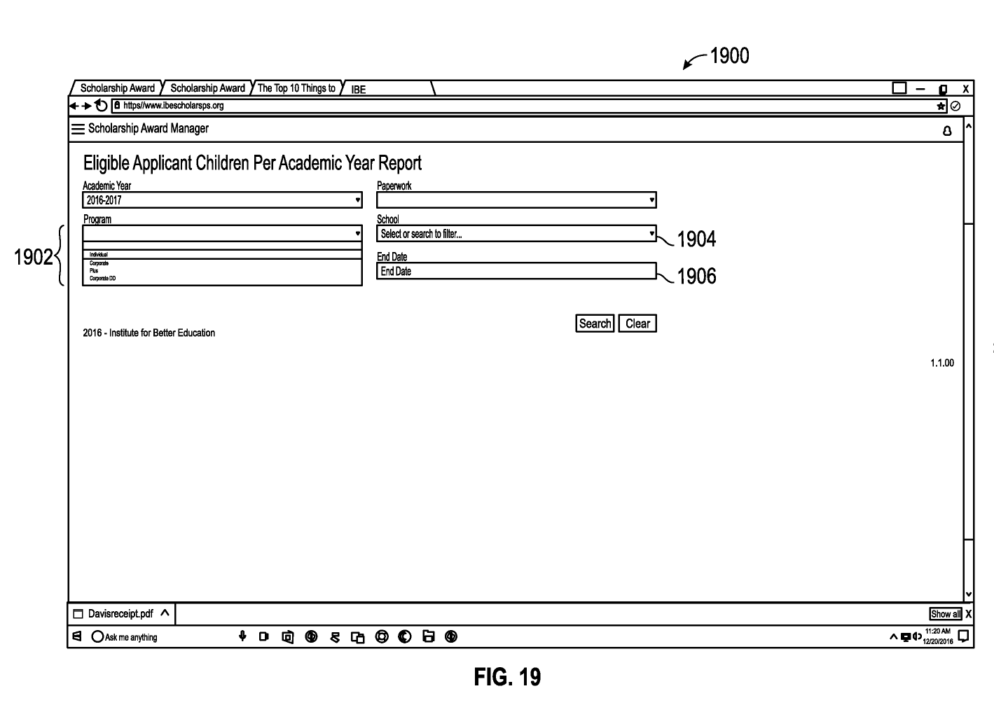

More particularly and referring now to FIG. 19, a screen shot of an exemplary report configuration page 1900 includes a fund selection drop down menu 1902 for selecting one of the available scholarship fund categories for which an interim report is desired, such as, for example: i) original (sometimes also referred to as individual); ii) plus; iii) low income corporate; and iv) D/D. The page 1900 also includes a school drop down menu 1904 and an end date field 1906, inasmuch as interim reports may be run periodically to facilitate awarding scholarships monthly, quarterly, semi-annually, annually, or as needed to zero out accumulating donations.

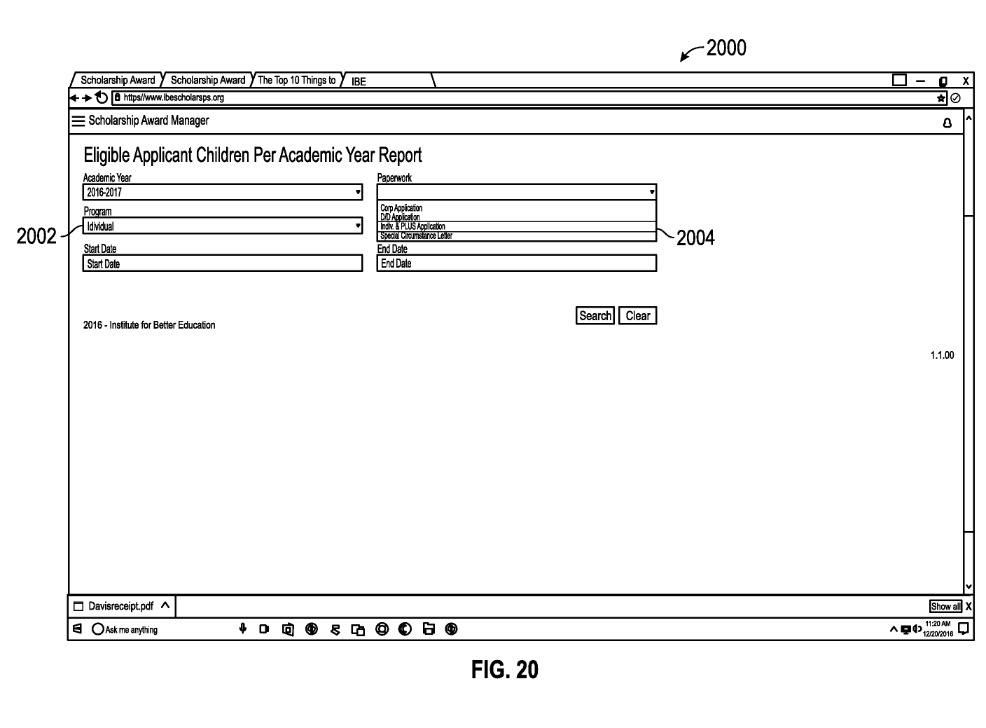

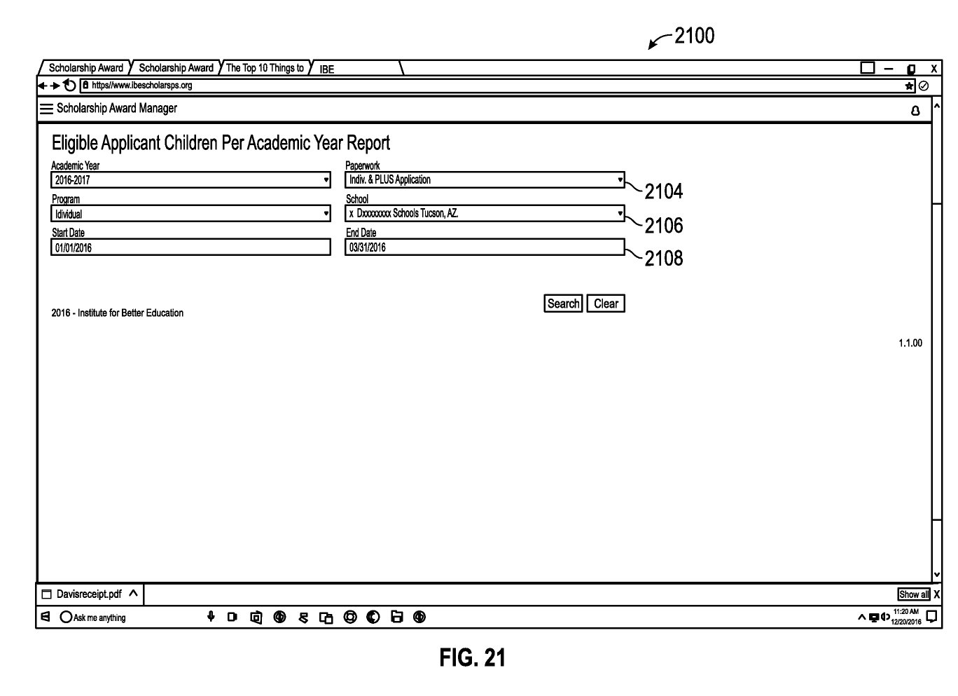

With reference to FIG. 20, a screen shot of an exemplary configuration page 2000 indicates that an interim report is requested for original source funds (field 2002) for all students applying for original and plus scholarships (field 2004). FIG. 21 is an exemplary configuration page 2100 indicating that the administrator has selected an interim report for individual and plus applicants (field 2104) for a particular school, namely, Desert School in Tucson, Ariz. (field 2108), for the period ending Mar. 31, 2016 (field 2108).

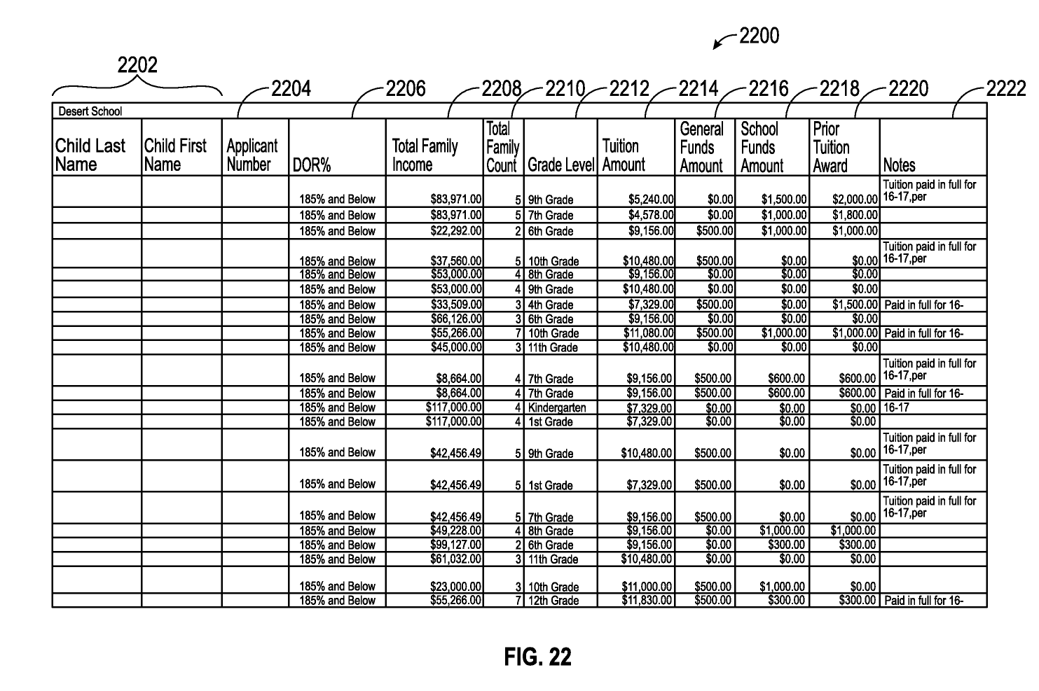

FIG. 22 is an exemplary report 2200 depicting funds donated by individual donors to a particular school, and the allocation of those funds among eligible students at that school (Desert School). The report 2200 includes each child's name 2202, applicant number 2204, department of revenue (DOR) family income level indicator 2206 (e.g., 185% of federal poverty level), number in household 2210, grade level 2212, tuition amount 2214, a general fund award for the current term 2216, a school funds award for the current term 2218, prior year awards 2220, and a notes column 2222. This is the matrix upon which the scholarship committee makes awards. The committee sends the report to the school to suggest numbers from the available funds directed by individual donors to a particular school, whereupon the school confirms or proposes adjustments to the awards and returns the recommended allocations to the STO. All awards are subjectively allocated, until the available funds are drawn down to a predetermined reserve amount (or zero). In an embodiment, a student may be given a nominal award to preserve eligibility in subsequent years for which a prior award (e.g., plus) is required.

A similar process is repeated to allocate funds to students from general funds which were not directed to any particular school. For the general fund, the STO generates a similar report, but since the funds were not earmarked for any particular school, the school's input is not sought. The STO subjectively allocates the general fund money to particular students based on needs, regardless of where they attend school. One factor is the total funds allocated to a school, including total recommended donations to students of a particular school.

To complete the award process, the STO allocates funds from plus, low income corporate, and D/D funds in an analogous manner. That is, some corporations target their donations to a particular school, and some low income corporate donations may go to the corporate general fund.

At the end of the award process, any remaining original, plus, low income corporate, and D/D funds are set aside for future allocation to students at schools according to their eligibility for one or more of the scholarships. A key aspect of the present invention surrounds the notion that each program is allocated independently of the other programs, because the eligibility requirements for each fund are different and, hence, different groups of students are competing for the different funds. Students may apply for scholarships from as many sources for which they are eligible.

In partial summary, each student has the following potential scholarship sources: i) original (from individual donors); ii) plus (from individual donors); iii) low income corporate (from corporate donors); and iv) D/D (from corporate donors. Each of the foregoing funds also have a general (not targeted) fund component that is separately allocated, resulting in eight discrete funding sources In addition, the original and plus funds have a recommended component, resulting in a total of ten funding sources. Significantly, however, each eligible student matrix for each fund is retrieved from the same central database managed by SAM, resulting in operational and computational efficiencies.

The foregoing scholarship awards are then entered into SAM, on a student-by-student basis. Alternatively, SAM may be configured to retrieve all the interim reports and populate a global matrix for all awards to all students, and then sort them by school.

In accordance with aspects of the invention, SAM allows a registered applicant to view all awarded scholarships on a single page and to access, for any school year, award letters pertaining to the scholarships. In addition, the applicant portal permits an applicant to apply online for multiple academic years, for example, when the student is eligible for scholarships for more than one year at the time of application.

It should be noted that the statutory schemes define an eligible private school as a non-public (and non-charter) school operating within the state for which a tax credit is available (e.g., Arizona), so long as the school does not discriminate based on race or other protected classes, and further provided that teachers and other personnel having unsupervised contact with students are fingerprinted.

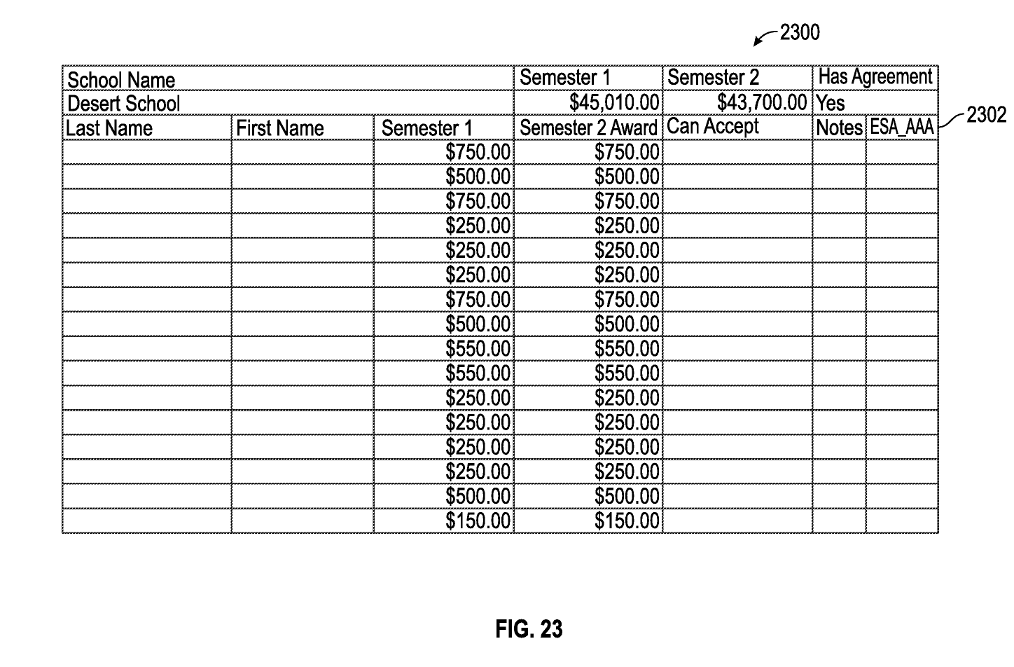

Once all awards are determined for all students at a particular school, a separate check (or EFT) is typically processed for each fund. Before processing a check, the STO advises the school of the amount they will be receiving for each student for the various funds, and asks the school to confirm that the student is registered with the school and has a tuition balance due. In an embodiment, this may be done using a “School Scholarship Acceptance Verification” Report 2300 of the type shown in FIG. 23.

In particular, the report 2300 includes a final column indicating whether the student has received ESA (“voucher”) funds or funds from another STO which prohibits the student from receiving funds from multiple STOs—either circumstance can render certain students ineligible to receive scholarships.

Before remitting award payments to the schools, SAM populates each applicant record with all the awards and the sources from which they came. In one embodiment this may be done manually; alternatively, the awards may be automatically retrieved from the various interim reports and used to populate the student records.

After the payments are made to the schools, all the records are indicated as paid for auditing purposes.

Refunds may be required if student withdraws or tuition is already paid in full. In such cases, the school sends a check back to the STO, and indicates each student's name, the amount of each students' refund and type of fund (source), and the reason for the refund. SAM then traces backward and puts the money back into the appropriate funds. This is possible because SAM kept track of where the funds came from during the award process. Also, sending one check per fund to each school helps sort out refunds as well, because the school knows and reports back to the STO as to which fund(s) the refund came from.

In accordance with a further aspect of the present invention, SAM may be configured to upload scholarship award data into an accounting module such as QuickBooks. In contrast to prior art systems which were only able to upload donations into QuickBooks in their entirety, SAM only uploads donations starting with the previous day and earlier. This not only saves time, but enables the STO to balance books on a daily basis.

A computer application is provided performing the steps of: prompting a donor to indicate whether a combined state tax credit and federal deduction is sought, or whether a federal charitable deduction alone is sought; prompting the donor to enter an original donation amount; prompting the donor to enter a first recommended recipient for the original donation amount; prompting the donor to enter a plus donation amount; prompting the donor to enter a second recommended recipient for the plus donation amount; and simultaneously executing a single credit/debit transaction for both the original and plus donation amounts.

In an embodiment, the application is further configured to simultaneously displaying said donor's prior year donation and prior year recommended recipient on a single page.

In an embodiment, the application is further configured to prompt the donor to click on indicia of said prior year recommended recipient to thereby recommend the same recipient for the current year.

In an embodiment, the application is further configured to confirm that the first recommended recipient has previously registered with the STO;

merging the original donation amount with the first recommended recipient; and present the original donation amount and the first recommended recipient to a scholarship committee to further consider the recommendation.

In an embodiment, the application is further configured to confirm that the first recommended recipient has not previously registered with the STO; create a place holder for an unknown recipient; process a registration for the first recommended recipient; and after the first recommended recipient registers with the STO, merge the original donation amount with the first recommended recipient.

In an embodiment, the application is further configured to display a recommendation page which includes: a drop down menu for selecting from a list of registered schools; a blank field for entering a school which is not yet registered with the STO; and an amount field for entering a donation amount.

In an embodiment, the recommended recipient comprises one of: i) a student name; ii) a school name; and iii) a general fund.

A method is also provided for processing tuition tax credit donations. The method involves: during an interactive donor web session: prompting a donor to enter a first donation amount and a first recommended recipient for a first scholarship fund; prompting the donor to enter a second donation amount and a second recommended recipient for a second scholarship fund; and simultaneously executing a single credit/debit transaction for the combined first and second donation amounts. The method also involves, during an interactive applicant web session, registering at least one of the first and second recommended recipients. The method further involves merging one of the donation amounts with one of the recommended recipients, and subsequently providing a color coded visual indication that one of the donation amounts has or has not been linked with one of the recommended recipients.

In an embodiment, the interactive applicant web session comprises: prompting the applicant to enter a child's name, birth date, school name, grade level, and tuition amount; and prompting the applicant to identify one or more eligibility circumstances.

In an embodiment, the interactive applicant web session further comprises: prompting the applicant to enter the name and income for at least one additional household member; and displaying a summary of household members and total household income.

In an embodiment, the interactive applicant web session further comprises: determining, based on the eligibility circumstances and the total household income, which one of a plurality of scholarships the applicant is eligible for; and prompting the applicant to select which plurality of scholarships the applicant desires to apply for.

In an embodiment, merging comprises displaying a web page including: the selected scholarship awards; and respective visual indicia associated with selected scholarship award indicating the status of documentation required for eligibility.

In an embodiment, the visual indicia comprises: a first color indicating that eligibility requirements for a scholarship have been completed; a second color indicating that eligibility requirements for a scholarship have not been completed; and a third color indicating that the applicant is not eligible for a scholarship.

In an embodiment, the method also involves: storing information in an electronic database, for a plurality of applicants, relating to each scholarship for which each applicant has completed the eligibility requirements; retrieving, from the electronic database, all applicants eligible for a particular fund; generating, using a computer, a first report listing all applicants from a particular school who are eligible for scholarships from the particular fund; and awarding scholarships based on the first report.

In an embodiment, the method further involves: generating a plurality of reports, each listing all applicants eligible for a unique scholarship fund; populating, using the plurality of reports, a respective school report for a plurality of schools, each school report listing all applicants enrolled at that school and the scholarships for which each applicant is eligible; awarding scholarships using the school reports; generating award reports reflecting the awarded scholarships; and automatically populating applicant records to reflect the awarded scholarships using the award reports.

A method is also provided for allocating tuition tax credit scholarship awards, the method including: sequentially selecting successive student records from a list of students for a selected one of a plurality of award categories; confirming eligibility documentation for each student for the selected category; subjectively evaluating uploaded eligibility documents for each student record; constructing a list of proposed awards based on the uploaded documents; transmitting a list of the proposed awards to a school; receiving confirmation from the school for each student regarding current enrollment and status of unpaid tuition; and remitting a single payment to the school for all awards for the plurality of students for the selected award category.

A method is also provided for registering a family with a school tuition organization (STO). The method includes: providing access to an applicant portal; prompting the applicant to enter a parent name, address, and password; prompting the applicant to enter total family income and number of family members living in the household; prompting the applicant to enter, for each eligible child in the family, the child's name, private school name, birth date, grade, and tuition amount; prompting the applicant to disclose extenuating circumstances giving rise to financial hardships; prompting the applicant to disclose scholarship eligibility qualifications for at least two scholarship funds; and prompting the applicant to upload eligibility supporting documentation.

In an embodiment, the method includes displaying on a single page all scholarships awarded to the child.

In an embodiment, the method includes providing online access to award letters for multiple scholarship awards for at least one school year.

In an embodiment, the method includes prompting the applicant to apply for scholarships for more than one academic year.

As used herein, the word “exemplary” means “serving as an example, instance, or illustration.” Any implementation described herein as “exemplary” is not to be construed as preferred or advantageous over other implementations, nor is it intended to be construed as a model that must be literally duplicated

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed:

1. Computer code embodied in a non-transitive medium which, when executed by a processor, is configured to perform the steps of:
prompting a donor to indicate whether a combined state tax credit and federal deduction is sought, or whether a federal charitable deduction alone is sought;
prompting the donor to enter an original donation amount;
prompting the donor to enter a first recommended recipient for the original donation amount;
prompting the donor to enter a plus donation amount;
prompting the donor to enter a second recommended recipient for the plus donation amount; and
simultaneously executing a single credit/debit transaction for both the original and plus donation amounts.

2. The computer code of claim 1, further configured to perform the step of:
simultaneously displaying said donor's prior year donation and prior year recommended recipient on a single page.

3. The computer code of claim 2, further configured to perform the step of:
prompting the donor to click on indicia of said prior year recommended recipient to thereby recommend the same recipient for the current year.

4. The computer code of claim 1, further configured to perform the steps of:
confirming that the first recommended recipient has previously registered with the STO;
merging the original donation amount with the first recommended recipient; and
presenting the original donation amount and the first recommended recipient to a scholarship committee to further consider the recommendation.

5. The computer code of claim 1, further configured to perform the steps of:
confirming that the first recommended recipient has not previously registered with the STO;
creating a place holder for an unknown recipient; and
processing a registration for the first recommended recipient; and
after the first recommended recipient registers with the STO, merging the original donation amount with the first recommended recipient.

6. The computer code of claim 1, further configured to perform the step of displaying a recommendation page which includes:
a drop down menu for selecting from a list of registered schools; a blank field for entering a school which is not yet registered with the STO; and
an amount field for entering a donation amount.

7. The computer code of claim 1, wherein the recommended recipient comprises one of: i) a student name; ii) a school name; and iii) a general fund.

8. A method for processing tuition tax credit donations, comprising the steps of:
during an interactive donor web session: prompting a donor to enter a first donation amount and a first recommended recipient for a first scholarship fund; prompting the donor to enter a second donation amount and a second recommended recipient for a second scholarship fund; and simultaneously executing a single credit/debit transaction for the combined first and second donation amounts;
during an interactive applicant web session, registering at least one of the first and second recommended recipients;
merging one of the donation amounts with one of the recommended recipients; and subsequently
providing a color coded visual indication that one of the donation amounts has or has not been linked with one of the recommended recipients.

9. The method of claim 8, wherein the interactive applicant web session comprises:
prompting the applicant to enter a child's name, birth date, school name, grade level, and tuition amount; and
prompting the applicant to identify one or more eligibility circumstances.

10. The method of claim 9, wherein the interactive applicant web session further comprises:
prompting the applicant to enter the name and income for at least one additional household member; and
displaying a summary of household members and total household income.

11. The method of claim 10, wherein the interactive applicant web session further comprises:
determining, based on the eligibility circumstances and the total household income, which one of a plurality of scholarships the applicant is eligible for; and
prompting the applicant to select which plurality of scholarships the applicant desires to apply for.

12. The method of claim 11, wherein merging comprises
displaying a web page including:
the selected scholarship awards; and
respective visual indicia associated with selected scholarship award indicating the status of documentation required for eligibility.

13. The method of claim 12, wherein the visual indicia comprises:
a first color indicating that eligibility requirements for a scholarship have been completed;
a second color indicating that eligibility requirements for a scholarship have not been completed; and
a third color indicating that the applicant is not eligible for a scholarship.

14. The method of claim 13, further comprising:
storing in an electronic database, for a plurality of applicants, information relating to each scholarship for which each applicant has completed the eligibility requirements;
retrieving, from the electronic database, all applicants eligible for a particular fund;
generating, using a computer, a first report listing all applicants from a particular school who are eligible for scholarships from the particular fund; and
awarding scholarships based on the first report.

15. The method of claim 14, further comprising:
generating a plurality of reports, each listing all applicants eligible for a unique scholarship fund;
populating, using the plurality of reports, a respective school report for a plurality of schools, each school report listing all applicants enrolled at that school and the scholarships for which each applicant is eligible;
awarding scholarships using the school reports;
generating award reports reflecting the awarded scholarships; and
automatically populating applicant records to reflect the awarded scholarships using the award reports.

16. A method of allocating tuition tax credit scholarship awards, comprising the steps of:
sequentially selecting successive student records from a list of students for a selected one of a plurality of award categories;
confirming eligibility documentation for each student for the selected category;
subjectively evaluating uploaded eligibility documents for each student record;
constructing a list of proposed awards based on the uploaded documents;
transmitting a list of the proposed awards to a school;
receiving confirmation from the school for each student regarding current enrollment and status of unpaid tuition; and
remitting a single payment to the school for all awards for the plurality of students for the selected award category.

17. A method of registering a family with a school tuition organization (STO), comprising the steps of:
providing access to an applicant portal;
prompting the applicant to enter a parent name, address, and password;
prompting the applicant to enter total family income and number of family members living in the household;
prompting the applicant to enter, for each eligible child in the family, the child's name, private school name, birth date, grade, and tuition amount;
prompting the applicant to disclose extenuating circumstances giving rise to financial hardships;
prompting the applicant to disclose scholarship eligibility qualifications for at least two scholarship funds; and
prompting the applicant to upload eligibility supporting documentation.

18. The method of claim 17, further comprising displaying on a single page all scholarships awarded to the child.

19. The method of claim 17, further comprising providing online access to award letters for multiple scholarship awards for at least one school year.

20. The method of claim 17, further comprising prompting the applicant to apply for scholarships for more than one academic year.
